(19) United States
(12) Patent Application Publication
(10) Pub. No.: US 2003/0233482 A1
(43) Pub. Date: Dec. 18, 2003

(54) System and method for enhancing a user's web browsing experience

(76) Inventor: Nicholas C. Skrepetos, Eugene, OR (US)

Correspondence Address: MERCHANT & GOULD PC, P.O. BOX 2903, MINNEAPOLIS, MN, 55402-0903, US

(21) Appl. No.: 10/465,117

(22) Filed: Jun. 18, 2003

Related U.S. Application Data
(60) Provisional application No. 60/390,022, filed on Jun. 18, 2002.

(51) Int. Cl. G06F 15/16

(52) U.S. Cl. 709/250

(57) ABSTRACT

A system utilizes a browser toolbar or browser helper object to implement functionality that blocks unwanted advertisement and informational windows while a user is browsing a network. The system is initiated to receive specified events from a network browser. As the events are received, the events are analyzed to determine whether the window corresponding to the event is an unwanted advertisement or informational window. When the window corresponding to the event is an unwanted advertisement or informational window, the window is blocked by the system from being loaded or displayed.

### RELATED APPLICATIONS

This application claims the benefit of U.S. Provisional Application No. 60/390,022 filed Jun. 18, 2002, which is hereby claimed under 35 U.S.C. §119(e).

### FIELD OF THE INVENTION

The present invention relates to enhancing the user's web browsing experience and preventing unwanted advertising windows by providing a browser toolbar and browser helper object extension.

### BACKGROUND OF THE INVENTION

While browsing a network such as the World Wide Web, or “the web”, users are often presented with unwanted advertising windows or other informational windows that are activated when the user visits certain web-sites or clicks a link on a web-site or other page. In addition, these web-sites may leave behind a detailed history of a user's browsing habits. Some of this data, in particular the browser cache and cookies, can be utilized by other web-sites or client side applications to track both the movement and location of a user on the web. When confronted with an unwanted advertising window, a user may elect to close the window by using conventional methods such as clicking the close icon or depressing a key sequence to close the window.

### SUMMARY OF THE INVENTION

The present invention provides a system and method that detects and blocks unwanted advertising and informational windows that appear in a network browsing session. In one embodiment, the present invention provides a browser toolbar for implementing the detection and blocking functionality of the present invention. Utilizing the browser toolbar, the system can accurately detect the difference between desired and undesired windows. In addition, utilizing the browser toolbar system provides the end-user with a seamless, integrated, and a common method in which to access the program functions. In one embodiment, the browser toolbar may be repositioned and the number of displayed buttons may be altered. In an additional embodiment, feedback is provided to the user by a sound and/or icon changing so the user is kept informed about the operation of the program and the removal of unwanted browser windows. By removing or blocking/preventing unwanted advertisement or informational windows, the present invention assists the user's web browsing experience by increasing the speed of browsing and minimizing the level of unwanted information.

### BRIEF DESCRIPTION OF THE DRAWINGS

FIG. 1 illustrates an exemplary browser toolbar for providing the unwanted window blocking functionality in accordance with the present invention.

FIG. 2 illustrates an exemplary logic flow diagram for a window blocking process in accordance with the present invention.

FIG. 3 illustrates an exemplary logic flow diagram for an event analysis process in accordance with the present invention.

FIG. 4 illustrates an exemplary logic flow diagram for an unwanted window determination process in accordance with the present invention.

### DETAILED DESCRIPTION OF THE PREFERRED EMBODIMENT

In the following detailed description of exemplary embodiments of the invention, reference is made to the accompanied drawings, which form a part hereof, and which is shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

The present invention prevents unwanted advertisement or informational windows from activating while a user is browsing a network (e.g., the web). These unwanted advertisements or informational windows are often referred to as “ads” or “pop-up ads”. These pop-up ads are used by web-sites (i.e., web-site administrators) to divert users to products for which the web-site administrator is often paid to promote. Often, the pop-up ad is undesired by the user browsing the web, as it can slow the user's progress to their intended location. The present invention provides a browser toolbar by which the user may enhance their web browsing experience. The browser toolbar provides functionality for blocking the unwanted advertisement or informational window. While the following described embodiment of the present invention may refer to objects or events specific to certain platforms or network browsers, the present invention may be applied to many different platforms and many different network browsers (i.e., web browsers).

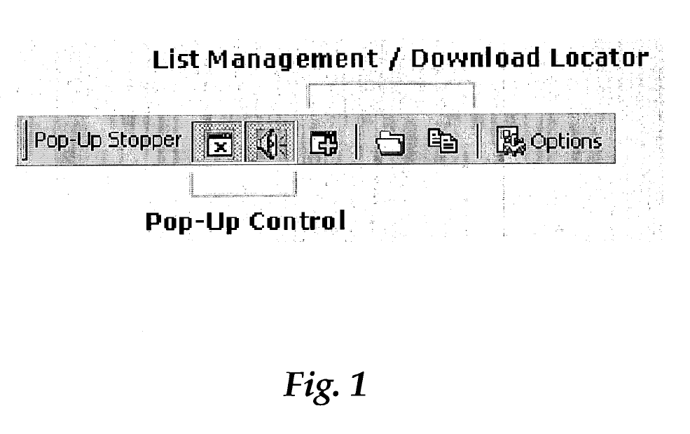

FIG. 1 illustrates an exemplary browser toolbar (100) for providing the unwanted window blocking functionality in accordance with the present invention. Browser toolbar 100 is often referred to as a toolbar extension, or a “toolband” extension. Certain platforms on computing devices provide a method in which browser extensions are registered to extend the functionality of the web browser. As computing devices, such as computers or mobile devices are well known in the art, they will not be described in detail herein. In one embodiment, the browser toolbar is a COM (“component object model”) extension that has full access to the COM interfaces exposed by the web browser. These interfaces may include the IWebBrowser and IWebBrowser2 interfaces exposed by the web browser sold under the trademark INTERNET EXPLORER, and the like. These interfaces provide a method in which an application (i.e., program) can access and intercept the various features of the web browser, including navigation, webpage content, and events. Also included in this interface is the ability to derive an interface which provides the ability to locate connection points within the interfaces and to eventually receive browser events. In one example, the application can “hook” into the events stream and be notified of specified events as the web browser operates. Through these events, an application can determine when a new window is being created, when the user navigates to a new URL, the completion of a page load, and the like. In another embodiment, a system hook is used to hook the mouse events so that the application can determine the amount of time that has passed since the user last clicked the mouse. In addition, the COM interfaces exposed by the web browser and associated events and connection points are hooked by using another type of COM object referred to as a Browser Helper Object (BHO). These are also loaded at the startup of the web browser and can utilize the same techniques described below to prevent advertisement or informational windows. The toolbar acts as a “host” or “communication” interface to the BHO. In one embodiment, the stopping and analyzing technology resides in the toolbar extension itself or in the BHO and is communicated to from either a toolbar extension or an external controlling application. The toolbar and browser helper object can be used independently and are not reliant on each other for the prevention of unwanted advertising windows, although the two can be used in conjunction to provide a functional interface for the user.

Exemplary browser toolbar 100, presents the user with options for activating/deactivating the blocking functionality, activating/deactivating the audio indicator when an unwanted advertisement or informational window is blocked, as well as other options for customizing the properties of the unwanted window blocking system to meet the preferences of the user. In further embodiments, the visual characteristics of the browser toolbar may be changed, or the options available to the user may be expanded or reduced without departing from the spirit and scope of the present invention.

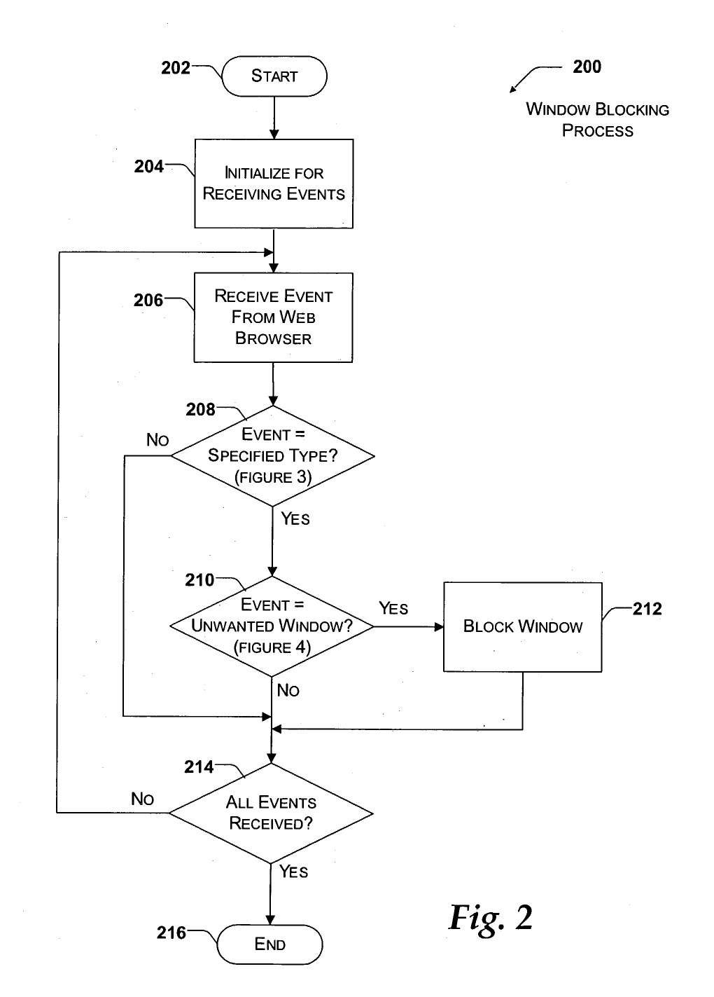

FIG. 2 illustrates an exemplary logic flow diagram for a window blocking process (200) in accordance with the present invention. Process 200 begins at start block 202 where the system for blocking unwanted advertisement or informational windows is loaded onto a computing device that includes a network browser is capable of browsing a network such as the web. The process continues at block 204.

At block 204, the system is initialized for receiving events from the web browser as the user browses the network. Certain interfaces exposed by the network browser are used by the system to access and monitor the events of the web browser as the user navigates the network. In one example, a certain interface of the network browser is used to locate the connection point interface in order to hook the browser events. The connection point interface is used to command the network browser to pass the browser events to the system for blocking the unwanted advertisement or informational windows. Once the system is initialized for receiving events from the web browser, processing proceeds to block 206.

At block 206, a browser event or “event” is received from the network browser, indicating that some operation has occurred relating to the network browser. In a further embodiment, the system may not receive all events from the network browser, but instead may query the network browser for notification of only certain events, such as when a new browser window is initiated. Still other embodiments may utilize an intermediary application to monitor the events of the network browser before notification of a certain event is provided to the system. Once the event is received, process 200 moves to decision block 208.

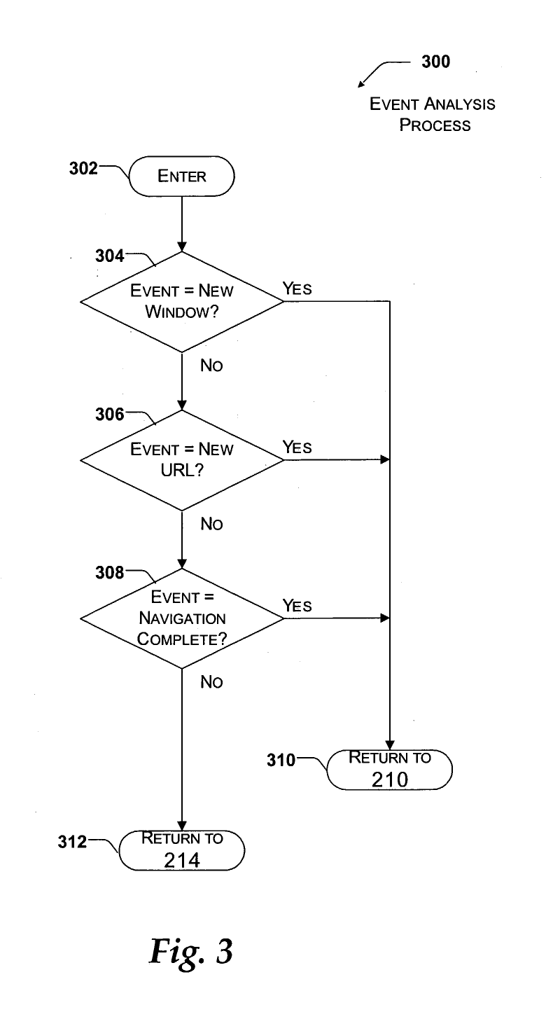

At decision block 208, a determination is made whether the event that occurred within the browsing session is a specified type of event that may correspond to an unwanted advertisement or informational window. An illustrative process for determining the type of event is further described in the discussion of FIG. 3 below. If the event is not one of the specified types of events, processing advances to decision block 214. However, if the event is one of the specified types of events, processing proceeds to decision block 210.

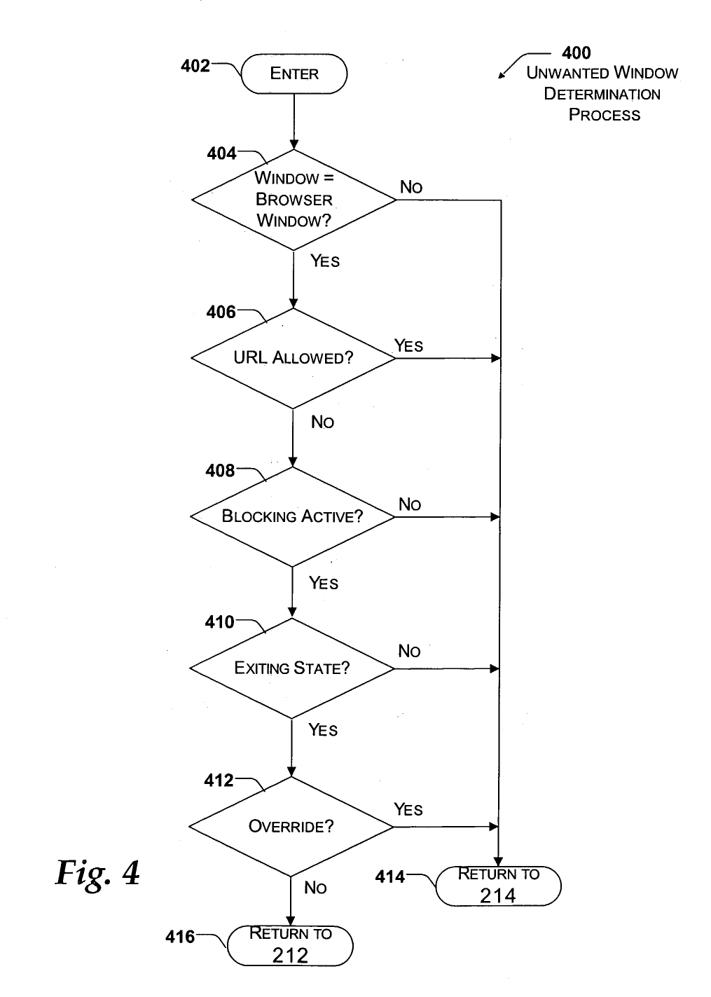

At decision block 210, a determination is made whether the event indicates that the window associated with the event is an unwanted advertisement or informational window. An illustrative process for determining whether the event indicates that the window associated with the event is an unwanted window is described in the discussion of FIG. 4 below. When the window associated with the event is not an unwanted advertisement or informational window, processing advances to decision block 214. Alternatively, if the window associated with the event is an unwanted advertisement or informational window, processing proceeds to block 212.

At block 212, since the event corresponded to an unwanted window, the window is blocked from activation. In one embodiment, the system sets a cancel flag so that the network browser prevents the window from being created. Once the cancel flag is set, the system triggers an event to log the URL of the blocked window for future reference. Additionally, the system may play an optional alert sound or visual indicator so that the user is aware that a window has just been blocked. Furthermore, the windows caption and visible styles may be removed to hide the unwanted window, and remove its caption from the task bar. The window may additionally be moved to a position outside of the visible screen in case the window tries to re-display itself. After the window is blocked, processing proceeds to decision block 214.

At decision block 214, a determination is made whether all events from a particular browsing session have been received. If further events are still to be received, the browsing session is not complete and processing returns to block 206 to receive the next event. However, if no further events are to be received from the network browser, the browsing session is complete, and processing proceeds to block 216 where process 200 ends.

FIG. 3 illustrates an exemplary logic flow diagram for an event analysis process (300) in accordance with the present invention. Process 300 enters at block 302 when process 200 shown in FIG. 2 enters block 208. Process 300 continues at decision block 304.

At decision block 304, a determination is made whether the event corresponds to the network browser creating a new window. A new window may be created when the user clicks a link on a webpage that triggers a new window via a window.open JavaScript command or similar command. Alternatively, a new window may be created when the user right-clicks and selects “Open in New Window” from a context menu in the browser, when the user selects to open a new window from the menu provided by the network browser itself, when the user clicks a shortcut from the desktop, folder, program menu, or quick launch bar that causes a new browser window to open, or other methods for opening a new window. If the event corresponds to a network browser creating a new window, processing advances to block 310 where process 300 returns to decision block 210 of process 200 shown in FIG. 2. However, if the event does not correspond to the network browser creating a new window, processing proceeds to decision block 306.

At decision block 306, a determination is made whether the event corresponds to an event that is fired just before the network browser navigates to a new URL (uniform resource locator). The navigation to the new URL may be a result of a user clicking on a hyperlink, typing in a new URL in the address line, and the like. If the event corresponds to an event fired just prior to the network browser navigating to a new URL, processing advances to block 310 where process 300 returns to decision block 210 of process 200 shown in FIG. 2. However, if the event does not correspond to an event fired just prior to the network browser navigating to a new URL, processing proceeds to decision block 308.

At decision block 308, a determination is made whether the event corresponds to an event that is fired just after the network browser has navigated to a URL. Again, the navigation to the URL may be a result of a user clicking on a hyperlink, typing in a new URL in the address line, and the like. If the event corresponds to an event fired just after the network browser has navigated to a URL, processing advances to block 310 where process 300 returns to decision block 210 of process 200 shown in FIG. 2. However, if the event does not correspond to an event fired just after the network browser has navigated to a URL, processing proceeds to block 312 where process 300 returns to decision block 214 of process 200 shown in FIG. 2.

In other embodiments, further events may be added or removed from process 300 to provide other events that may correspond to an unwanted window as the technology for producing advertisement or informational windows progresses. For example, an event fired by the browser that an item (graphic, etc.) is starting to download, and when there is a change in download progress may also be analyzed to determine whether the associated window is an unwanted advertisement or informational window. Additionally, an event notifying that a page is complete loaded and ready to be displayed may also be used by the system. When this event is received, it is safe to access the elements, or code on a webpage as the page has been rendered in memory for display. In further embodiments, the system may use these events to determine that the page is still in the process of being loaded, and reset the timestamp of the last navigation. Resetting the timestamp of the last navigation assists the system in determining whether a user really initiated a browser window or the web page initiated the browser window.

FIG. 4 illustrates an exemplary logic flow diagram for an event determination process (400) in accordance with the present invention. Process 400 enters at block 402 when process 200 shown in FIG. 2 enters block 210. Process 400 continues at decision block 404.

At decision block 404, a determination is made whether the window corresponding to the event is a browser window corresponding to the network browser and not a standard window or another folder. Determining if the window is a browser window avoids blocking standard folders from opening. The method examines the window class, and determines if the module belonging to this class contains the name of the network browser's executable image. If the window is not associated with the network browser all further processing and checking is terminated to avoid closing the wrong type(s) of windows. Accordingly, if the window corresponding to the event is not a browser window, processing advances to block 414. At block 414, process 400 returns to decision block 214 of process 200 shown in FIG. 2. However, if the window corresponding to the event is a browser window, processing proceeds to decision block 406.

At decision block 406, a determination is made whether the URL of the window corresponding to the event is a URL specifically listed as an allowed URL. If the URL of the window is an allowed URL, processing advances to block 414. At block 414, process 400 returns to decision block 214 of process 200 shown in FIG. 2. However, if the URL is not specifically allowed, then it may still need to be blocked and processing proceeds to decision block 408.

At decision block 408, a determination is made whether the blocking functionality provided by the blocking system is activated by the user. The user may have selected the blocking functionality to be activated or deactivated according to their preference. If the blocking functionality is not activated, processing advances to block 414. At block 414, process 400 returns to decision block 214 of process 200 shown in FIG. 2. However, if the blocking functionality is activated, processing proceeds to decision block 410.

At decision block 410, a determination is made whether the browser is in an “exiting state”, or being closed by the user. In one embodiment, any windows created when exiting (closing) the browser are prevented from opening. The current timestamp of the event is compared to the last saved mouse clicked timestamp to see how “soon” this event was triggered after clicking the mouse. If the time is short (e.g., <300 ms), the window is allowed to be created, as it is assumed that the last saved mouse clicked timestamp was triggered by the user clicking a link or menu option. If the time is longer (e.g., >300 ms), the time is compared to when the last navigation event occurred. If the comparison shows a substantial difference (e.g., greater than 4000 ms) the window is allowed, as the difference indicates the window was not triggered from any page. The time difference between the appearance of the window and the last navigation event is internally adjustable. Accordingly, if the browser is not in an exiting state, processing advances to block 414. At block 414, process 400 returns to decision block 214 of process 200 shown in FIG. 2. However, if the browser is in an exiting state, processing proceeds to decision block 412.

At decision block 412, a determination is made whether an override key has been depressed by the user when the event occurred. If an override key is active, processing advances to block 414. At block 414, process 400 returns to decision block 214 of process 200 shown in FIG. 2. However, if there is no override key active, processing proceeds block 416. At block 416, processing returns to block 212 of process 200 shown in FIG. 2, where the window is blocked.

Process 400 described above may include other criteria for determining whether a window corresponding to an event is an unwanted advertisement or informational window. Furthermore, process 400 may vary depending on the type of event (see discussion of FIG. 3) that has been fired by the network browser. For example, further criteria that may be examined to determine whether a window is an unwanted window may include a special “window allowed” property that is checked to determine if the window has previously been allowed by a hot key, or previously passed all the criteria. If a window has been allowed by the user once, even if it would fail the allowed window test, the system can quickly bypasses all decision processing and allow the navigation to continue while minimizing processor usage.

The criteria may also include aspect ratio checking. For aspect ratio checking an assumption is made that unwanted windows are wider than they are tall, or taller then they are wide. In one embodiment, the aspect ratio of the window is determined by computing two separate aspect ratio components as indicated below:

Component1(width vs. height)=width of current browser/height of current browser

Component2(height vs. width)=height of current browser/width of current browser

If either Component1 or Component2 is less that a predetermined threshold (e.g. 50%) the window is considered a unwanted window. This threshold is adjustable. Once the window has been found to be a unwanted window, the window is blocked as described according to block 212 shown in FIG. 2. In a further embodiment, checking the aspect ratio is usually avoided when the window has received previous navigations. The ability to avoid the aspect ratio criteria ensures that when user is resizing the Window, and makes it taller then wide, or wider than tall, the window is not suddenly considered an unwanted window if it has received previous navigations.

The criteria for determining whether a window corresponding to an event is an unwanted window may also include browser size versus default size checking. According to this requirement, the window size is checked against the default size that is stored in the registry. The window size is checked because when a new browser is started or link is opened, and it is not resized with JavaScript or similar code, the window is the default or last saved size as stored in the registry. In one embodiment, the size of the browser window is checked only when preventing unwanted windows in aggressive mode, zero browser windows have been created, or when the window has not been navigated to any URL's.

Yet another determining factor may include determining whether the window is visible. If the window is not visible, it may mean that the window is still being created. Additionally, a check may be performed to see how many browsers exist in the system that are active, but may still be hidden. If there is only a single browser, or the browser does not have a frame name, the window is allowed to be opened since the browser is probably the first browser being launched, and is just loading the default home page and sizing itself.

The above specification, examples and data provide a complete description of the manufacture, use, and composition of the invention. Since many embodiments of the invention can be made without departing from the spirit and scope of the invention, the invention resides in the claims hereinafter appended.

I claim:

1. A computer-implemented method for blocking unwanted advertisement and information windows while browsing a network using a network browser, comprising:
providing at least one of a browser toolbar and browser helper object within the network browser, wherein at least one of the browser toolbar and browser helper object implements functionality for blocking the unwanted advertisement and information windows;
initiating receipt of events from the network browser;
receiving the events from the network browser;
analyzing each event to determine whether a window corresponding to the event is an unwanted window; and
initiating the functionality to block the window corresponding to the event when the event corresponds to an unwanted window.

2. The computer-implemented method of claim 1, wherein at least one of the browser toolbar and the browser helper object includes options for customizing the functionality for blocking the unwanted advertisement and informational windows.

3. The computer-implemented method of claim 2, wherein the options include an option of activating and deactivating the functionality for blocking the unwanted advertisement and informational windows and an option of activating and deactivating at least one of audio and visual indicator that an unwanted window has been blocked.

4. The computer-implemented method of claim 1, wherein initiating receipt of events further comprises:
utilizing an interface exposed by the web browser to locate a connection point interface; and
utilizing the connection point interface to command the network browser to pass the events from the web browser to an application associated with the functionality for blocking the unwanted advertisement and information windows.

5. The computer-implemented method of claim 1, wherein receiving the events from the network browser further comprises determining the type of event being received.

6. The computer-implemented method of claim 1, wherein receiving the events from the network browser further comprises querying the network browser for notification of certain events that occur with relation to the network browser.

7. The computer-implemented method of claim 1, wherein receiving the events from the network browser further comprises receiving the events at an intermediary application that provides notification of receipt of specified event to an application associated with at least one of the browser toolbar and the browser helper object.

8. The computer-implemented method of claim 1, wherein analyzing each event further comprises means for determining whether a window corresponding to the event is an unwanted window.

9. The computer-implemented method of claim 1, wherein initiating the functionality to block the window further comprises setting a cancel flag so that the network browser prevents the window corresponding to the event from being created.

10. The computer-implemented method of claim 1, wherein initiating the functionality to block the window further comprises providing at least one of an audio and visual indicator to a user, such that the user is notified that the window corresponding to the event has been blocked.

11. The computer-implemented method of claim 1, wherein initiating the functionality to block the window further comprises repositioning the window corresponding to the event to a position outside of the visual screen, such that the window is unable to be re-displayed.

12. A computer-readable medium encoded with computer-executable instructions for performing a method comprising:
providing at least one of a browser toolbar and browser helper object within a network browser, wherein at least one of the browser toolbar and browser helper object implements functionality for blocking unwanted windows;
monitoring events associated with the network browser;
analyzing each event to determine the type of event;
analyzing each event to determine whether a window corresponding to the event is an unwanted window; and
initiating the functionality to block the window corresponding to the event when window corresponding to the event is an unwanted window.

13. The computer-readable medium of claim 12, wherein at least one of the browser toolbar and the browser helper object includes options for customizing the functionality for blocking the unwanted windows.

14. The computer-implemented method of claim 1, wherein monitoring the events associated with the network browser further comprises at least one of querying the network browser for notification of certain events that occur with relation to the network browser, and receiving the events at an intermediary application that provides notification of receipt of specified event to an application associated with at least one of the browser toolbar and the browser helper object.

15. The computer-implemented method of claim 1, wherein analyzing each event further comprises means for determining whether a window corresponding to the event is an unwanted window.

16. The computer-implemented method of claim 1, wherein initiating the functionality to block the window further comprises at least one of setting a cancel flag so that the network browser prevents the window corresponding to the event from being created providing at least one of an audio and visual indicator to a user when an unwanted window is blocked, and repositioning the window corresponding to the event to a position outside of the visual screen.

17. A method for blocking unwanted windows while browsing a network, comprising:
providing at least one of a browser toolbar and browser helper object within a network browser, wherein at least one of the browser toolbar and browser helper object implements functionality for blocking the unwanted advertisement and information windows;
initiating receipt of events from the network browser;
receiving the events from the network browser;
analyzing each event according to a set of criteria to determine whether a window corresponding to the event is an unwanted window, wherein the criteria for analyzing the window corresponding to the event includes means for determine whether a window corresponding to the event is an unwanted window; and
blocking the window corresponding to the event when the window corresponding to the event is an unwanted window, such that the window is prevented from opening.

18. The method of claim 17, further comprising means for determining the type of event that is received from the network browser.

19. The method of claim 18, wherein the types of events includes at least one of a group comprising an event corresponding to when the network browser opens a new window, an event that is fired just before the network browser navigates to a new uniform resource locator, an event that is fired just after the network browser has navigated to a uniform resource locator, an event fired when an item is starting to download, an event fired when a change in download progress occurs, and an event fired when notifying that a page is completely loaded.

20. The method of claim 17, wherein blocking the window further comprises at least one of setting a cancel flag so that the network browser prevents the window corresponding to the event from being created providing at least one of an audio and visual indicator to a user when an unwanted window is blocked, and repositioning the window corresponding to the event to a position outside of the visual screen.
